(19) United States
(12) Patent Application Publication
(10) Pub. No.: US 2005/0039209 A1
(43) Pub. Date: Feb. 17, 2005

(54) Hotel video checkout with email account statement

(75) Inventors: Peter F. Klebanoff, Sioux Falls, SD (US); Mark L. Burd, Sioux Falls, SD (US); Steven D. Truckenmiller, Sioux Falls, SD (US); Debra R. Tech Coffey, Salem, SD (US); Randall J. Califf, Sioux Falls, SD (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: LodgeNet Entertainment Corporation, Sioux Falls, SD (US)

(21) Appl. No.: 10/946,752

(22) Filed: Sep. 22, 2004

Related U.S. Application Data
(63) Continuation of application No. 09/597,376, filed on Jun. 19, 2000.

(51) Int. Cl. H04N 7/18; H04N 7/173

(52) U.S. Cl. 725/78; 725/80; 725/82; 725/105

(57) ABSTRACT

An entertainment system for a lodging establishment such as a hotel includes a head end which provides television programming, movies, video games, Internet access and guest services to televisions within individual guest rooms. The guest services is provided by the head end include video checkout, though which the guest may review a folio of charges to the guest's room and approve those charges for payment on the guest's credit card. A receipt for the approved charges is sent by e-mail to an e-mail address provided by the guest during the check-in process, or during video checkout.

### CROSS-REFERENCE TO RELATED APPLICATION(S)

This application is a continuation of U.S. patent application Ser. No. 09/597,376, filed Jun. 19, 2000 and entitled HOTEL VIDEO CHECKOUT WITH E-MAIL ACCOUNT STATEMENT.

### BACKGROUND OF THE INVENTION

The present invention relates to entertainment systems for use in the lodging industry. In particular, the present invention is an entertainment system which includes video checkout though which a guest may review charges, approve the charges, and have a statement of account automatically sent to the guest's e-mail address.

The past two decades have seen the wide scale introduction of entertainment systems in hotels and other lodging facilities which provide a variety of services to the guests through the guest room television. The range of services typically includes regular off-air television programming, pay-per-view movies which are either scheduled or available on demand, Internet access, and guest services such as video shopping and video checkout.

The video checkout feature allows a guest to review a folio of charges to his or her room in preparation to checkout. This allows the guest to review charges before going through the checkout procedure at the front desk, so that when the guest reaches the front of the checkout line, he or she is ready to discuss any specific items in question. It also allows the guest to avoid the front desk checkout procedure entirely. If the charges shown on screen during video checkout are all correct, the guest may approve those charges, and the charges will be automatically made to the guest's credit card. In that case the guest leaves the room keys in the room after having performed video checkout and approving the charges. A statement of account is then mailed to the address which had been given to the hotel by the guest at the time of check in.

This video checkout system provides convenience to the guest as well as to the hotel. It shortens checkout lines, particularly at busy times of the day since at least some of the guests will avail themselves of the video checkout feature. There are, however, several disadvantages of present video checkout systems. First, the video checkout system does not eliminate the personal handling of account statements by hotel staff. A paper copy of the statement must still be generated (since the guest needs a statement for expense account and tax purposes). In addition, the statement must be placed in an envelope which is addressed and has the proper postage applied. The statements must be placed into the proper envelopes, so that the statement of account goes to the proper guest at the right address, and all of the envelopes must be gathered up with other mail to be taken to the Post Office.

Second, from the guest's perspective, video checkout results in a delay in receiving an account statement. Depending upon delays in processing at the hotel as well as mail delays, some guests may receive a statement from the hotel in a day or two, while others may have to wait a week or more. This is particularly an issue with international travelers, and may discourage the use of the video checkout feature despite its other advantages. The delay in receiving a statement from the hotel may result in a delay in the guest generating an expense account report.

An alternative to having the statement sent by mail is to stand in line at the front desk for checkout, even after approving the charges through the video checkout system. This is inconvenient to the guest, and slows down the entire checkout process for all guests. It also requires that the front desk personnel be involved in the printing out of statements at the time of checkout, which slows down the checkout process.

Still another alternative, which is used in some hotels, is to provide an in-room printer. As part of the video checkout process, the guest can print a statement on the in-room printer. This is, however, a very expensive solution to the disadvantages of video checkout. If the printer is typically used by a guest only to print out a statement of account, the cost of the printer is difficult to justify. Equipment used in the entertainment system is typically provided by the entertainment system vendor and is not directly paid for by the hotel. Since the entertainment system vendor typically has no way of directly recovering the costs of the printers, the widespread use of in-room printers simply to allow printout of an account statement during video checkout does not appear to be economically justified.

### BRIEF SUMMARY OF THE INVENTION

The present invention is a hotel entertainment system including a video checkout feature. During the video checkout process, the guest may elect to have an account statement e-mailed to an e-mail address which has been provided by the guest during the check in process, or which is provided by the guest during the video checkout process. Upon approval of the charges and authorization of payment on a credit card, the host computer of the entertainment system formats an account statement which is suitable for sending by e-mail and which contains necessary information for expense account reimbursement and tax purposes, and then sends the statement to the guest's e-mail address.

### BRIEF DESCRIPTION OF THE DRAWINGS

FIG. 1 is a block diagram of a hotel entertainment system.

FIGS. 2A and 2B are a diagram illustrating the video checkout process of the invention.

### DETAILED DESCRIPTION

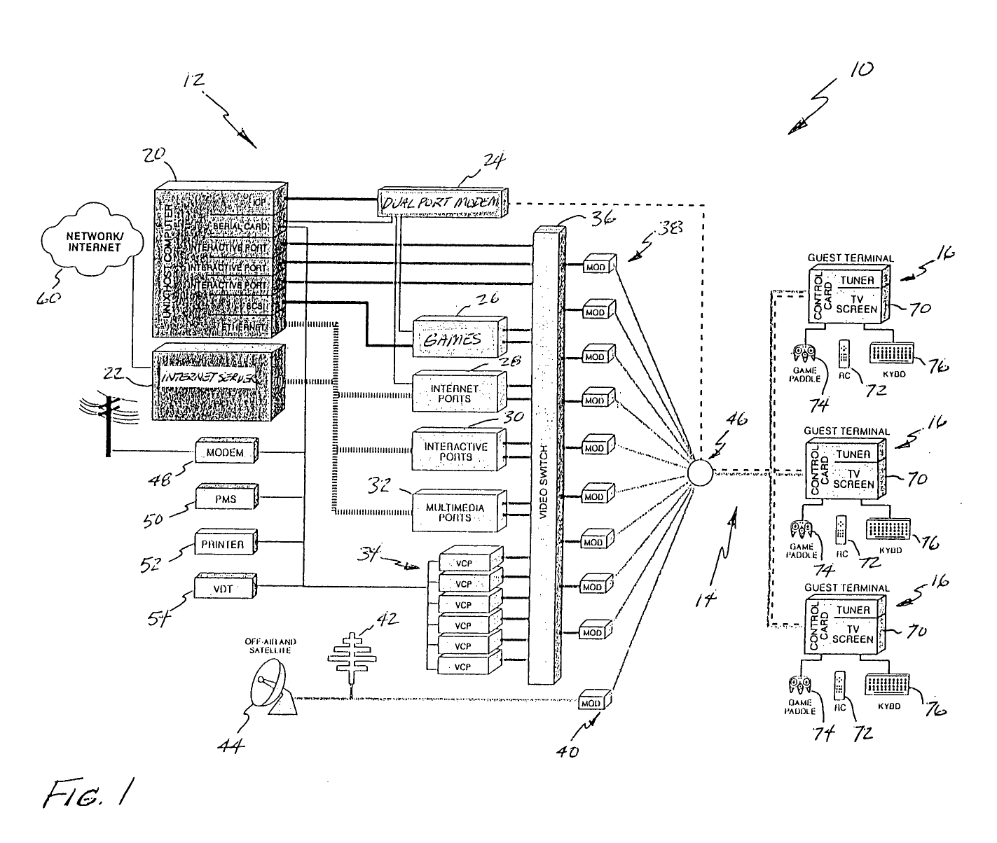

FIG. 1 is a block diagram showing a system overview of hotel entertainment system 10 which delivers television programming, video-on-demand (VOD) movies, interactive video games, Internet access, and other interactive video services to individual guest rooms of a hotel or other lodging facilities. Entertainment system 10 includes three primary portions: headend 12, distribution system 14, and guest terminals 16.

Audio/video RF signals for all channels of the cable television system are provided from headend 12. The audio/video RF signals from headend 12 may include off-air local television channels, direct broadcast satellite programing, interactive menus, video-on-demand programming, interactive video games, Internet services, and other interactive video and multi-media services, including video checkout. Based upon system control data transmitted and received via distribution system 14 from guest terminals 16, headend 12 controls the operation of interactive menus, VOD movies, interactive games, Internet services, and other interactive services.

Distribution system 14 is preferably an MATV cable distribution system conventionally used in hotels and other lodging facilities. Distribution system 14 permits the transmission of both audio/video RF signals, as well as two-way data and digital communication (typically RF) signals between headend 12 and guest terminals 16.

Headend 12 includes UNIX host computer 20 (UHC), Internet server and network interface 22, dual ported modem 24, game platform 26, Internet ports 28, interactive ports 30, multi-media ports 32, on-demand movie system 34, video switch 36, a bank of selectable modulators 38, a bank of pre-assigned modulators 40, off-air antenna 42, satellite dish 44, combiner/diplexer 46, telecom modems 48, property management system (PMS) 50, printer 52, and video display terminal (VDT) 54.

UNIX host computer (UHC) 20 is, in a preferred embodiment, a Pentium II or Pentium III computer which runs UNIX operating code, together with software for coordinating the operations components of headend 12. UHC 20 houses several different computer cards and components. In the embodiment shown in FIG. 1, UHC includes an intelligent communications processor (ICP) card, a multi-port serial card, a number of interactive video port cards, an SCSI interface card, and an ethernet card. In addition, UNIX host computer 20 also houses storage devices such as floppy disk drive, a backup drive, a CD ROM drive, and a hard disk drive.

UHC 20 manages the operation of several other devices of headend 12, together with communication tasks. UHC 20 communicates with dual port modem (DPM) 24, on demand movie system 34, modem 48, property management system 50, printer 52, and video display terminal 54 over serial lines such as RS-232 lines connected to serial card of UHC 20.

UHC 20 is in charge of polling all of the guest terminals 16 for keystroke activity. The polling function is performed by ICP through DPM 24. ICP communicates with DPM 24 over a high speed serial line. The results of the polling are received back over distribution system 14 and are routed through diplexer/combiner 46 to DPM 24. Depending upon the particular keystrokes that are returned, DPM 24 will return the keystrokes to the serial card of UHC 20, to game platform 26, or to Internet ports 28 through serial lines, or other services which may be implemented.

UHC 20 communicates with game platform 26 by a high speed serial line between the SCSI port of UHC 20 and game platform 26. For example, game programs stored by UHC 20 are downloaded to the individual game engines of game platform 26 based upon game ordering and selection made by the guest through guest terminals 16.

UHC 20 communicates through its ethernet card with Internet server 22, Internet ports 28, interactive ports 30, and multi-media ports 32. Internet server 22 provides a communication interface between headend 12 and Internet 60.

The outputs of interactive ports of UHC 20, as well as the outputs of game platform 26, Internet ports 28, interactive ports 30, multi-media ports 32, and on demand movie system 34 are baseband audio/video signals which are provided to inputs of video switch 36. The outputs of video switch 36 are connected to a bank of modulators 38. Video switch 36 is controlled by UHC 20 to route particular baseband audio/video outputs to the inputs of selected modulators of bank 38.

Game platform 26 is a device that allows a guest to purchase an interactive video game and to view that game at guest terminal 16. Game platform 26 sends game audio and video and game data through video switch 36, one of the modulators 38, combiner/diplexer 46 onto distribution system 14 to guest terminals 16.

Game platform 26 receives information from UHC 20 from the SCSI card. Keystrokes which are received back from the guest terminal 16 are received by DPM 24 and routed to the appropriate game engine of game platform 26 which corresponds to the guest who has sent the keystroke.

Internet ports 28 send audio and video information from the Internet to the appropriate guest terminal. The output of internet ports 28 are connected to the appropriate modulator, so that the audio and video is placed on a channel to which the guest terminal of the guest conducting the Internet session is tuned.

Interactive ports 30 provide audio and video associated with menuing and other interactive services. These include guest services such as video checkout, interactive shopping, surveys, opinion polls, and room service ordering.

Multi-media ports 32 provide a wide variety of different audio and visual programs to a subscriber. These can include, for example, video directories, advertising, and other information services.

On demand movie system 34 includes an array of video sources, each capable of providing baseband audio/video signals. In the particular embodiment shown in FIG. 1, on demand movie system 34 includes an array of video cassette players (VCP's). In this embodiment, each VCP is an off the shelf video cassette player that is dedicated to playing one movie title. A video cassette is pre-loaded into each VCP. The number of VCP's and movie titles depends upon the number of guest rooms at any given property, and typically will be more than the six VCP's shown by way of example in FIG. 1.

In other embodiments, on demand movie system 34 uses other forms of video sources. For example, video disk players may be used instead of, or in addition too video cassette players (VCP's). Alternatively, one or more digital video servers may act as video sources of on demand movie system 34. In each of these embodiments, on demand movie system 34 provides a number of individual audio/video baseband outputs to individual inputs of video switch 36.

Video switch 36 is a device that receives baseband audio and video signals at its input ports, and routes those signals to output ports which are connected through individual lines to inputs of individual modulators 38. Video switch 36 is capable of connecting any one of the baseband audio/video signals received at its inputs to any one more of the bank of modulators 38. Although one video switch is shown in FIG. 1, multiple video switches can be used as needed. Operation of video switch 36 is under control of UHC 20, which tells video switch 36 which input port connect to which output port.

Modulators 38 convert baseband video and audio signals received at their inputs to RF and deliver the signals to combiner/diplexer 46. Each modulator is set to modulate on a specific frequency or RF channel. The outputs of modulators 38 are connected to inputs of combiner 46.

As shown in FIG. 1, headend 12 also includes cable and off-air programming which is received through satellite dish 44 and off-air antenna 42, respectively. Associated with satellite dish 44 and antenna 42 are receiver and processor circuitry which condition the signals they supply to modulators 40 and then to combiner/diplexer 46.

UHC 20 communicates with the owner/operator of entertainment system 10 through modem 48. The system owner and operator is typically remote from the hotel facility, and must receive usage, billing, and financial information in order to settle accounts with the hotel. In addition, control and trouble shooting information can be communicated to and from UHC 20 through modem 28.

Property management system (PMS) 50 is a computer system operated by the hotel to track charges incurred by individual guests. These charges typically include room charges, as well as dining charges, room service, telephone charges, charges for use of hotel entertainment system 10, and a variety of other charges. As charges related to system 10 are incurred, UHC 20 communicates that information to PMS 50. During video checkout operations, UHC 20 communicates with PMS 50 to obtain the data necessary to show the guest, on guest terminal 16, a folio of charges associated with that guest's room. The video checkout system allows the guest to approve the charges and to authorize payment for those charges through a credit card number previously given to the hotel and stored in property management system 50.

Guest terminal 16 includes television 70, remote control 72, game controller 74, and keyboard 76. Each television 70 has a television screen for viewing, and has an associated television tuner and a control card which interfaces guest terminal 16 with distribution system 14 and headend 12.

The control card of guest terminal 16 receives keystrokes from remote control 72, game controller 74, and keyboard 76. In the case of remote control 72, the keystrokes are in the form of infrared signals which are transmitted from an infrared transmitter within remote control 72 to an infrared receiver associated with television 70. The keystrokes are passed by the control card to distribution system 14 back to headend 12. The guest selects options by viewing interactive menus on the screen of television 70 and pressing keys of remote control 72 accordingly. These key presses are received and stored by the control card. In response to polling signals from headend 12, the control card provides system data representing the keystrokes to headend 12 which indicates which key or keys have been pressed.

Video game controller (or game paddle) 74 is connected by a cable to television 70. Alternatively, game paddle 74 can be connected via an IR link. Keystrokes from game paddle 74 are supplied to the control card, and then are supplied as part of system data in response to polling of guest terminals 16 by headend 12. In some embodiments, game paddle 74 includes keys which duplicate keys on remote control 72 so that game paddle 74 can be used to initiate interactive sessions and order programs without the need to use remote control 72.

Keyboard 76 is connected to television 70 either through a cable or by an IR link. Keystrokes from keyboard 76 are supplied by the control card of guest terminal 16 to headend 12 in response to polling. Keyboard 76 is useful for interactive services such as Internet, e-mail and computer games. Keyboard 76 can, in some cases, be used to initiate interactive sessions and order programs rather than using remote control 72.

When a guest wishes to use entertainment system 10, the guest presses a key on remote control 72 to turn on television 70. A welcome screen will first appear on the TV screen of guest terminal 16. If the guest wishes to view off-air or satellite programming which is free programming, those channels are accessible by pressing the channel up or channel down keys or remote control 72. If, on the other hand, the guest wishes to view and perhaps select other offerings of system 10, such as on demand movies, Internet access, interactive video games, or interactive services, the welcome channel screen provides an instruction to the user to select a menu. Upon pressing the menu key, a signal is provided to the control card 50, which stores the keystroke information until the next time that guest terminal 16 is polled by headend 12. In response to polling, the keystroke indicating pressing of the menu key is supplied to headend 12. This results in UHC 20 selecting one of the interactive ports which are either internal to UHC 20 or are part of interactive ports 30 to display a series of interactive menus which are navigated by the guest through the use of keystrokes supplied by remote control 72 (or alternatively game paddle 74 or keyboard 76). Depending upon the selections made by the guest in response to the screens which are displayed, UHC 20 will activate the requested service which may be provided by game platform 26, Internet ports 28, interactive ports 30, multi-media ports 32, or on demand movie system 34. UHC 20 routes the selected output through video switch 36 to a modulator representing one of the available channel and sends digital control signals to the control card of the guest terminal 16 to cause guest terminal 16 to tune to the channel on which the requested service is to appear.

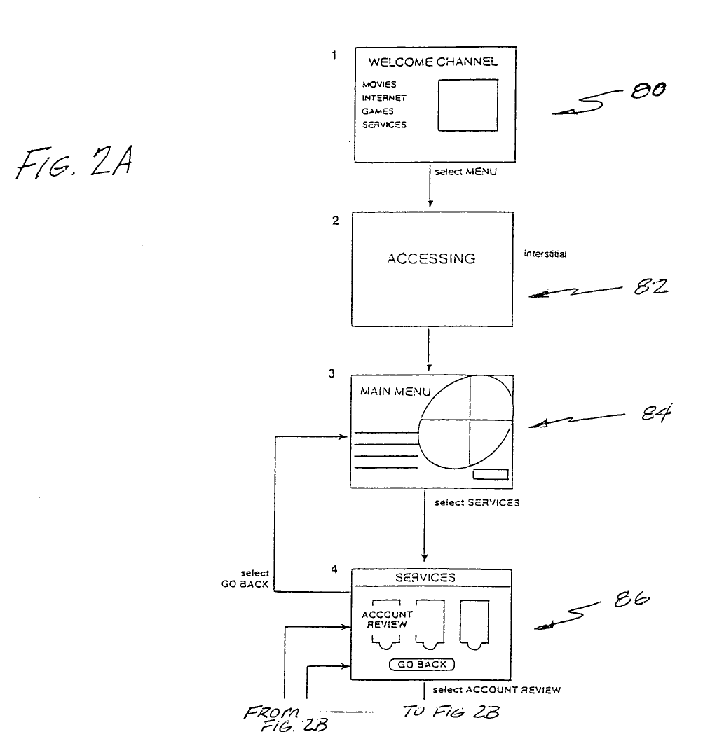

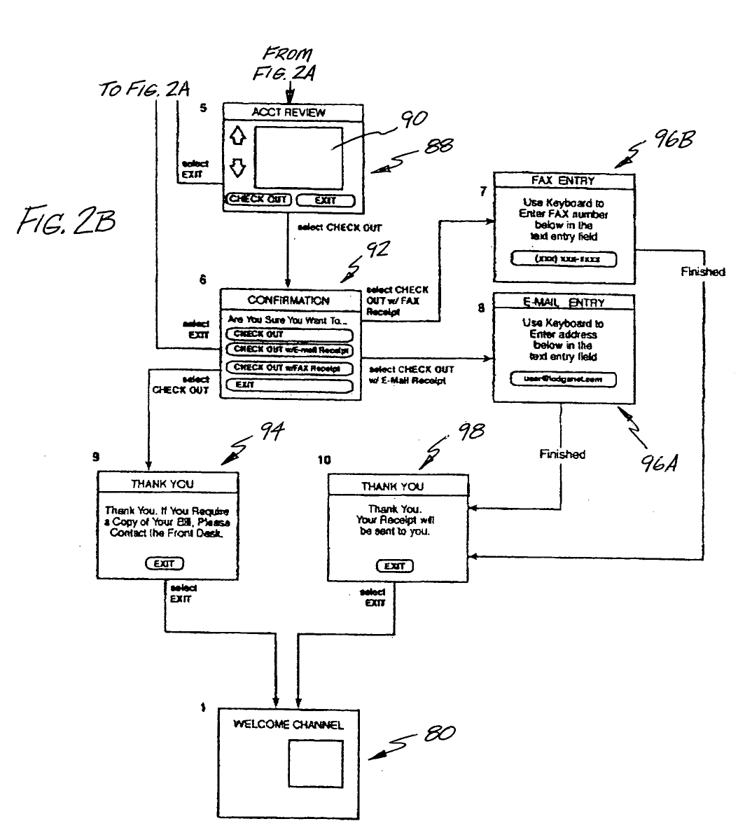

The present invention relates to an improved video checkout service provided by system 10. FIGS. 2A and 2B illustrate this improved video checkout by showing screens which appear on the guest terminal TV, and the path taken from screen to screen depending upon the keystrokes entered by the guest in response to the screens. Welcome channel screen 80 appears when the guest first turns on the TV. The guest is instructed to press the MENU key to access the main menu.

Accessing screen 82 is a temporary screen that is displayed while UHC 20 sets up an interactive port for an interactive session with the guest in response to the MENU key being pressed, UHC 20 selects the interactive port, sets up the video switch to connect the port to a particular modulator 38, and sends a control signal to tune guest terminal 16 to the channel produced by that modulator. Main menu screen 84 is then displayed, with a list of selectable options such as movies, Internet, games, and services. If the guest is interested in video checkout, the guest will select “services” from main menu screen 84. This may be done, for example, by pressing navigational keys to highlight one of the offerings on the main menu, and then pressing a select key.

As a result of selecting services from the main menu, services screen 86 is displayed on the TV screen. The guest is given the choice of highlighting one of several picture icons (or “picons”) or highlighting “go back”. One of the picons which is labeled in screen 86 is “Account Review”. This is the picon which is selected to progress with a video checkout.

As shown in FIG. 2A, selecting “go back” will result in a return to main menu screen 84. Selecting “Account Review” will progress to Account Review screen 88, which is shown in FIG. 2B.

Account Review screen 88 includes a central display area 90 on which account information about the guests account is displayed. Navigational arrows pointed up and down are located to the left of display area 90. By highlighting the up and down navigational arrows, the guest can scroll the information displayed on display area 90 up or down in order to see all of the charges listed on the guest's account. When Account Review screen 88 has been selected by the guest, UHC 20 accesses property management system (PMS) 50 to obtain the account information associated with that particular guest. The identity of the guest is known because each guest terminal has a unique address, and UHC 20 knows which guest terminal has requested an account review. The necessary information provided by PMS 50 is formatted for display on Account Review screen 88 by UHC 20.

After reviewing the information on Account Review screen 88, the guest can exit Account Review screen 88, which results in UHC 20 again displaying Services screen 86. Alternatively, the guest may select “checkout,” which results in Confirmation screen 92 being displayed.

The purpose of Confirmation screen 92 is to verify that the guest does indeed want to perform a video checkout (as opposed to having pressed the wrong key). If the guest has made an incorrect keystroke, or has changed his or her mind about checking out using video checkout, the selection of “exit” will return to Services screen 86.

There are two other choices shown on Confirmation screen 92. They are “checkout” and “checkout with e-mail receipt”.

If the guest selects “checkout,” “Thank You” screen 94 is displayed. UHC 20 provides information to property management system 50 indicating that video checkout has been completed. If the guest wants a copy of the bill, the guest must either contact the front desk to have a bill sent to the guest by mail, or must go to the front desk and stand in the checkout line in order to get it printed. This is the traditional way in which video checkout is performed. After receiving Thank You screen 98, the guest has only one option: to select “exit.” Upon making that selection, the guest is returned to Welcome Channel 80.

The other option available from Confirmation screen 92 is video checkout with an e-mail receipt. When that selection is made from Confirmation screen 92, E-Mail Entry screen 96 is displayed on the TV of guest terminal 16. Screen 96 instructs the guest to use keyboard 76 to enter an e-mail address which will appear as keystrokes are made on the entry field of screen 96. This interactive entry of information onto the screen is done by sending keystroke information as a response to polling by UHC 20, which then results in an updating of screen 96 to reflect the results of the keystrokes of keyboard 76. When the keyboard entry is complete, the guest presses a key such as “enter” indicating that the guest is finished entering the e-mail address. UHC 20 checks the address to see that it is in a proper form and then causes Thank You screen 98 to be displayed. Screen 98 confirms a receipt will be e-mailed and gives the user only one option: to select “exit.” The selection of “exit” causes the Welcome Channel screen 80 to again be displayed. Upon the completion of a video checkout with e-mail receipt, UHC 20 formats the guest account information into a format which can be sent by e-mail and sends the e-mail file from its ethernet card to Internet server, which in turn sends the e-mail over the Internet to the guest's e-mail address. The guest's credit card number is not displayed and is not included in the e-mail.

The e-mail receipt automatically provided by system 10 allows the guest to receive a receipt much quicker than if a hard copy of the receipt must be printed and sent by mail. It involves less involvement by the hotel staff and is much more efficient for the guest and hotel. It also avoids the need for the guest to stand in a checkout line to get a hard copy.

In other embodiments of the invention, e-mail address information can be entered at the time of check in. In that case, screen 96 can display the previously entered e-mail address (which was retrieved by UHC 20 as part of the information from PMS 50). In that case, the guest does not need to enter an e-mail address again, but rather can either confirm the e-mail address shown, or make corrections through the use of keyboard 76.

In some embodiments of the invention, a log is maintained by UHC 20 of e-mails which have been sent from the particular hotel. Alternatively, this log may be maintained by the operator of the entertainment system 10 for all of the different hotels being served.

UHC 20 ordinarily will deliver e-mails immediately upon a successful video checkout operation being completed. E-mails will be originated only once. UHC 20 or Internet server 22 may, however, have the capability of automatically re-sending the e-mail upon certain default conditions.

Information required to be on the e-mail receipt include date, an itemized listing of charges, and location information. Preferably, the location information should include name, address, phone, and e-mail address, (if available) of the hotel or other lodging facility.

The return address (reply to) of the e-mails sent by UHC 20 as part of the video checkout process use the hotel's e-mail address if available. If no e-mail address if available for the hotel, then an e-mail address of the owner/operator entertainment system 10 is used.

For security of the guest's credit card number, the e-mail receipt will not include the credit card number, or other information that may be sensitive to the guest. The e-mailed receipt should preferably mention that a credit card number is not listed for reasons of the guest's security.

Although the present invention has been described with reference to preferred embodiments, workers skilled in the art will recognize that changes maybe made in form and detail without departing from the spirit and scope of the invention.

1. An entertainment system comprising:
a plurality of guest terminals;
an input device to allow guests to select among multimedia services options by receiving key strokes;
a distribution system connected to the guest terminals;
a headend which communicates with the guest terminals over the distribution system, the head end providing the guest terminals with multimedia services and tracking charges associated with guest selected multimedia services;
wherein the headend communicates with a property management system for tracking charges associated with the entertainment system and other hotel charges to a guest accounts, storing payment information associated with the guest account, formatting charges incurred by the guest account, and electronically transmitting a receipt.

2. The entertainment system of claim 1 wherein the property management system transmits an electronic receipt upon video checkout by a guest.

3. The entertainment system of claim 1 wherein the headend creates a log of electronically transmitted receipts.

4. The entertainment system of claim 1 wherein the receipt is electronically transmitted as an e-mail.

5. The entertainment system of claim 1 wherein the receipt is electronically transmitted as a facsimile.

6. A method of providing automated checkout by a guest from a lodging facility having an entertainment system with a headend connected through a distribution system to a plurality of guest terminals located in guest rooms of the lodging facility, the method comprising:
maintaining a listing of charges to a guest account;
providing an option on the entertainment system for the guest to review the listing of charges of the lodging facility;
accessing the listing of charges upon a request by the guest through a guest terminal in a room occupied by the guest;
displaying for review on the guest terminal a listing of charges to the guest's account;
performing a checkout of the guest based upon the listing of charges in response to a selection made by the guest at the guest terminal;
sending a receipt electronically to a destination provided by the guest, which includes a checkout receipt for the listing of charges; and
maintaining a log of receipts sent electronically.

7. The method of claim 6 wherein the receipt includes date information, charges information, and lodging facility location information.

8. The method of claim 6 and further comprising:
prompting the guest to enter the destination in response to the selection made by the guest.

9. The method of claim 6 wherein sending a receipt electronically comprises:
sending an e-mail to an e-mail address provided by the guest.

10. The method of claim 9 and further comprising:
providing a return address to an e-mail account maintained by the lodging facility sending the receipt.

11. The method of claim 6 wherein sending a receipt electronically comprises:
sending a facsimile transmission to a facsimile phone number provided by the guest.

12. The method of claim 6 wherein performing a checkout of the guest further comprises:
authorizing payment for changes through a credit card number previously given to the hotel and stored in the property management system.

13. A method of providing automated checkout by a guest from a lodging facility having an entertainment system with a headend connected through a distribution system to a plurality of guest terminals, wherein the headend is in communication with a property management system, the method comprising:
storing a receipt delivery destination provided by the guest;
maintaining a listing of charges to an account of the guest;
providing an option on the entertainment system for the guest to review the listing of charges of the lodging facility;
accessing the property management system to obtain the listing of charges upon a request by the guest;
displaying for review on the guest terminal a listing of charges to a guest's account;
performing a checkout of the guest based upon the confirmed listing of charges in response to a selection made by the guest at the guest terminal;
formatting the data containing the charges to the guest's account to an appropriate form in response to a choice of receipt delivery destination provided by the guest; and
sending a receipt electronically to the receipt delivery destination provided by the guest, which includes a checkout receipt for the listing of charges and excludes sensitive information of the guest.

14. The method of claim 13 wherein sending a receipt electronically comprises:
sending an e-mail to an e-mail address provided by the guest for the receipt delivery destination.

15. The method of claim 14 wherein the receipt is sent immediately upon a confirmation of video checkout of the lodging facility.

16. The method of claim 13 wherein sending a receipt electronically comprises:
sending a facsimile transmission to a facsimile phone number provided by the guest for the receipt delivery destination.

17. The method of claim 13 wherein the receipt includes date information, charges information, and lodging facility location information.

18. The method of claim 13 and further comprising:
prompting the guest to enter a destination in response to the selection made by the guest.

19. The method of claim 13 wherein performing a checkout of the guest further comprises:
authorizing payment for charges through a credit card number previously given to the hotel and stored in the property management system.

20. A method of providing automated checkout by a guest from a lodging facility having an entertainment system with a headend connected through a distribution system to a plurality of guest terminals located in guest rooms of the lodging facility, the method comprising:
providing an option on the entertainment system for the guest to review a listing of charges of the lodging facility;
accessing a property management system in communication with the head end to obtain the listing of charges upon a request by the guest through a guest terminal in a room occupied by the guest;
displaying for review on the guest terminal a listing of charges to the guest's account;
performing a checkout of the guest based upon the listing of charges in response to a selection made by the guest at the guest terminal; and
sending a receipt electronically to a destination provided by the guest, which includes a checkout receipt for the listing of charges.

21. The method of claim 20 wherein the receipt includes date information, charges information, and lodging facility location information.

22. The method of claim 20 and further comprising:
prompting the guest to enter a destination in response to the selection made by the guest.

23. The method of claim 20 wherein sending a receipt electronically comprises:
sending an e-mail to an e-mail address provided by the guest.

24. The method of claim 20 wherein sending a receipt electronically comprises:
sending a facsimile transmission to a facsimile phone number provided by the guest.

25. The method of claim 20 wherein performing a checkout ofthe guest further comprises:
authorizing payment for changes through a credit card number previously given to the hotel and stored in the property management system.

26. A method of providing automated checkout by a guest from a lodging facility having an entertainment system with a headend connected through a distribution system to a plurality of guest terminals, the method comprising:
providing an option on the entertainment system for the guest to review a listing of charges of the lodging facility;
accessing a property management system to obtain the listing of charges upon a request by the guest;
displaying for review on the guest terminal a listing of charges to a guest's account;
performing a checkout of the guest based upon the listing of charges in response to a selection made by the guest at the guest terminal;
formatting the data containing the charges to a guest's account to an appropriate form in response to a choice of receipt delivery destination provided by the guest; and
sending a receipt electronically to a destination provided by the guest, which includes a checkout receipt for the listing of charges.

27. The method of claim 26 wherein sending a receipt electronically comprises:
sending an e-mail to an e-mail address provided by the guest.

28. The method of claim 26 wherein sending a receipt electronically comprises:
sending a facsimile transmission to a facsimile phone number provided by the guest.

29. The method of claim 26 wherein the receipt includes date information, charges information, and lodging facility location information.

30. The method of claim 26 and further comprising:
prompting the guest to enter the destination in response to the selection made by the guest.

31. The method of claim 26 wherein performing a checkout of the guest further comprises:
authorizing payment for charges through a credit card number previously given to the hotel and stored in the property management system.
